(19) United States
(12) Patent Application Publication
(10) Pub. No.: US 2022/0375277 A1
(43) Pub. Date: Nov. 24, 2022

(54) FUEL EFFICIENCY SCORE MANAGEMENT DEVICE AND FUEL EFFICIENCY SCORE MANAGEMENT METHOD

(71) Applicant: TOYOTA JIDOSHA KABUSHIKI KAISHA, Aichi-ken (JP)

(72) Inventor: Yukinori II, Toyota-shi (JP)

(21) Appl. No.: 17/742,399

(22) Filed: May 12, 2022

(30) Foreign Application Priority Data
May 20, 2021 (JP) 2021-085563

(51) Int. Cl. G07C 5/06; B60W 40/13; G06Q 30/02

(52) U.S. Cl. CPC G07C 5/06; B60W 40/13; G06Q 30/0283; B60W 2520/00

(57) ABSTRACT

A fuel efficiency score management device includes: an acquisition section configured to acquire driving information as detected during driving by a sensor unit installed at a vehicle; a fuel efficiency scoring section configured to decide a fuel efficiency score corresponding to a reduction in carbon dioxide emissions based on the acquired driving information; a score storage section configured to store the fuel efficiency score; and an incentive awarding section configured to lower a usage fee for the vehicle according to the stored fuel efficiency score.

### CROSS-REFERENCE TO RELATED APPLICATION

This application is based on and claims priority under 35 USC 119 from Japanese Patent Application No. 2021-085563 filed on May 20, 2021, the disclosure of which is incorporated by reference herein.

### BACKGROUND

### Technical Field

The present disclosure relates to a fuel efficiency score management device and a fuel efficiency score management method.

### Related Art

Japanese Patent Application Laid-Open (JP-A) No. 2010-67226 discloses a fee collection system in which a usage fee of a driver of a vehicle that has respected an optimal travel speed on toll roads is reduced. Specifically, in the fee collection system described in JP-A No. 2010-67226, the fee is reduced according to an average speed of the vehicle, thereby encouraging the vehicle to cut carbon dioxide emissions when traveling on toll roads.

However, the fee collection system described in JP-A No. 2010-67226 is a system to reduce the fee on toll roads, and does not take carbon dioxide emissions of the vehicle when traveling on general roads into consideration.

### SUMMARY

The present disclosure provides a fuel efficiency score management device and a fuel efficiency score management method that are capable of effectively cutting carbon dioxide emissions from a vehicle.

A first aspect of the present disclosure is a fuel efficiency score management device including: an acquisition section configured to acquire driving information as detected during driving by a sensor unit installed at a vehicle; a fuel efficiency scoring section configured to decide a fuel efficiency score corresponding to a reduction in carbon dioxide emissions based on the acquired driving information; a score storage section configured to store the fuel efficiency score; and an incentive awarding section configured to lower a usage fee for the vehicle according to the stored fuel efficiency score.

In the fuel efficiency score management device according to the first aspect, the acquisition section acquires the driving information as detected during driving by the sensor unit installed to the vehicle. The fuel efficiency scoring section decides the fuel efficiency score based on the driving information acquired by the acquisition section, and the fuel efficiency score is stored by the score storage section. Note that fuel efficiency scores serve as an index corresponding to a reduction in carbon dioxide emissions. The incentive awarding section lowers the usage fee for the vehicle according to the stored fuel efficiency score. Since a fuel efficiency score may also be decided for the vehicle when traveling on general roads, a usage fee discount corresponding to the fuel efficiency score may be applied to all of the vehicles managed by the fuel efficiency score management device. This enables a greater number of users to be encouraged to improve their fuel efficiency score, thereby enabling carbon dioxide emissions to be effectively cut.

A second aspect of the present disclosure is a fuel efficiency score management device includes an acquisition section configured to acquire driving information as detected during driving by a sensor unit installed to a vehicle, a fuel efficiency scoring section configured to decide a fuel efficiency score corresponding to a reduction in carbon dioxide emissions based on the acquired driving information, a score storage section configured to store the fuel efficiency score together with user information, and an incentive awarding section configured to award points to a user according to the stored fuel efficiency score.

In the fuel efficiency score management device according to the second aspect, the incentive awarding section awards points to the user according to the stored fuel efficiency score. This enables the user's desire to collect points to be heightened, thereby enabling carbon dioxide emissions to be effectively cut. Note that “points” refers here to a broad concept including points that may be used to cover part of the cost when purchasing goods, points that may be exchanged for predetermined goods, and so on.

A third aspect of the present disclosure, in the first aspect, may further include: a usage fee acquisition section configured to acquire a usage fee for the vehicle, wherein the incentive awarding section is configured to lower the usage fee according to the fuel efficiency score over a predetermined period.

In the fuel efficiency score management device according to the third aspect, the usage fee for the vehicle over each predetermined period is acquired by the usage fee acquisition section. The incentive awarding section lowers the usage fee according to the fuel efficiency score over the predetermined period. This enables a wide range of application to monthly payment schemes such as car leasing and subscription services.

In a fourth aspect of the present disclosure, in any one of the first aspect to the third aspect, the fuel efficiency scoring section may be configured to give a higher fuel efficiency score to a hybrid vehicle than to a conventional engine-powered vehicle, and to give a higher fuel efficiency score to an electric vehicle or a fuel cell vehicle than to a hybrid vehicle.

The fuel efficiency score management device according to the fourth aspect enables usage of vehicles that have lower carbon dioxide emissions than gasoline vehicles to be encouraged. Note that “gasoline vehicles” refers here to vehicles that only have an engine as a drive source. “Hybrid vehicles” refers to vehicles that have both an engine and a motor as drive sources. “Electric vehicles” refers to vehicles that do not have an engine, and use electrical energy from a charged battery to drive a motor. “Fuel cell vehicles” refers to vehicles that use electrical energy generated by fuel cells to drive a motor.

In a fifth aspect of the present disclosure, in any one of the first aspect to the fourth aspect, the fuel efficiency scoring section may be configured to decide the fuel efficiency score based on predetermined behavior including an idle time of the vehicle.

The fuel efficiency score management device according to the fifth aspect enables idling that contributes to carbon dioxide emissions to be reduced.

A sixth aspect of the present disclosure is a fuel efficiency score management method including: acquiring driving information as detected during driving by a sensor unit installed at a vehicle; deciding a fuel efficiency score corresponding to a reduction in carbon dioxide emissions based on the acquired driving information; storing the fuel efficiency score; and lowering a usage fee for the vehicle according to the stored fuel efficiency score.

A fuel efficiency score management method according to a seventh aspect includes acquiring driving information as detected during driving by a sensor unit installed to a vehicle, deciding a fuel efficiency score corresponding to a reduction in carbon dioxide emissions based on the acquired driving information, storing the fuel efficiency score together with user information, and awarding points to a user according to the stored fuel efficiency score.

The fuel efficiency score management device and the fuel efficiency score management method according to the present disclosure are capable of effectively cutting carbon dioxide emissions from a vehicle.

### BRIEF DESCRIPTION OF THE DRAWINGS

Exemplary embodiments of the present disclosure will be described in detail based on the following figures, wherein:

FIG. 1 is a schematic diagram illustrating an overall configuration of a fuel efficiency score management system according to an exemplary embodiment;

FIG. 2 is a block diagram illustrating a hardware configuration of a fuel efficiency score management device according to an exemplary embodiment;

FIG. 3 is a block diagram illustrating a functional configuration of a fuel efficiency score management device according to an exemplary embodiment;

FIG. 4 is a flowchart illustrating an example of a flow of fuel efficiency scoring processing in an exemplary embodiment;

FIG. 5 is a flowchart illustrating an example of a flow of incentive awarding processing in an exemplary embodiment; and

FIG. 6 is a flowchart illustrating an example of a flow of incentive awarding processing in a modified example.

### DETAILED DESCRIPTION

Explanation follows regarding a fuel efficiency score management system S including a fuel efficiency score management device 10 according to an exemplary embodiment, with reference to the drawings.

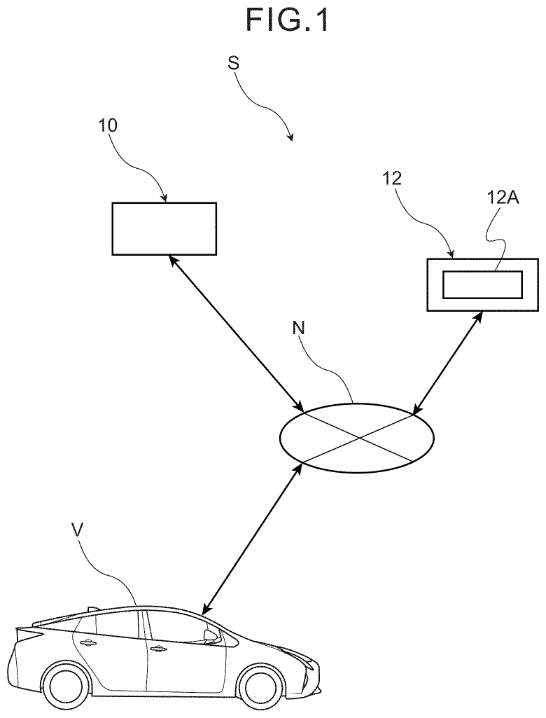

As illustrated in FIG. 1, the fuel efficiency score management system S of the present exemplary embodiment is configured including the fuel efficiency score management device 10, a server 12, and vehicles V. The fuel efficiency score management device 10, the server 12, and the vehicles V are connected over a network N. Note that although plural vehicles V are connected to the network N, only one vehicle V is illustrated in FIG. 1 for simplification.

The server 12 is a server owned by a company that manages the plural vehicles V. As an example, the server 12 of the present exemplary embodiment is owned by a company that runs a vehicle subscription service. A storage region 12A is provided to the server 12.

Note that a feature of the fuel efficiency score management device 10 of the present exemplary embodiment is that it decides a fuel efficiency score based on driving information for a vehicle V being used by a user through the subscription service, and reflects this fuel efficiency score in a usage fee.

Hardware Configuration of Fuel Efficiency Score Management Device 10

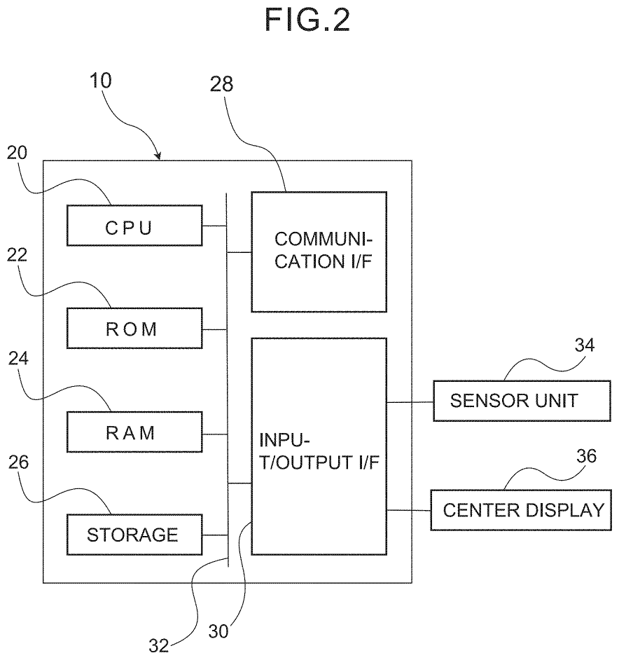

FIG. 2 is a block diagram illustrating a hardware configuration of the fuel efficiency score management device 10. As illustrated in FIG. 2, the fuel efficiency score management device 10 is configured including a central processing unit (CPU; processor) 20, read only memory (ROM) 22, random access memory (RAM) 24, storage 26, a communication interface (I/F) 28, and an input/output interface (I/F) 30. The respective configuration is connected so as to be capable of communicating with each other through a bus 32.

The CPU 20 is a central processing unit that executes various programs and controls various sections. Namely, the CPU 20 reads a program from the ROM 22 or the storage 26, and executes the program using the RAM 24 as a workspace. The CPU 20 controls the respective configuration and performs various computation processing according to the programs recorded in the ROM 22 or the storage 26.

The ROM 22 holds various programs and various data. The RAM 24 acts as a workspace to temporarily store programs or data. The storage 26 is configured by a hard disk drive (HDD) or a solid state drive (SSD), and holds various programs including an operating system, as well as various data. In the present exemplary embodiment, programs, various data, and so on for performing fuel efficiency scoring processing and incentive awarding processing are held in the ROM 22 or the storage 26.

The communication I/F 28 is an interface enabling the fuel efficiency score management device 10 to communicate with the server 12 and other equipment. Protocol such as a controller area network (CAN), Ethernet (registered trademark), long term evolution (LTE), fiber distributed data interface (FDDI), or Wi-Fi (registered trademark) may be employed therefor.

The input/output I/F 30 is electrically connected to a sensor unit 34 and a center display 36.

The sensor unit 34 includes plural sensors installed to each of the vehicles V, and is configured including sensors such as a vehicle speed sensor to detect the speed of the vehicle V, and an acceleration sensor to detect an acceleration rate of the vehicle V. The sensor unit 34 is also configured including a load sensor that detects a total weight of occupants and their baggage inside the vehicle cabin.

The center display 36 is for example provided at a position at a front section of the vehicle cabin so as to be visible to the driver, and various information such as navigation system information and entertainment-related information is displayed thereon. In the present exemplary embodiment as an example, the fuel efficiency score is displayed on the center display 36.

Functional Configuration of Fuel Efficiency Score Management Device 10

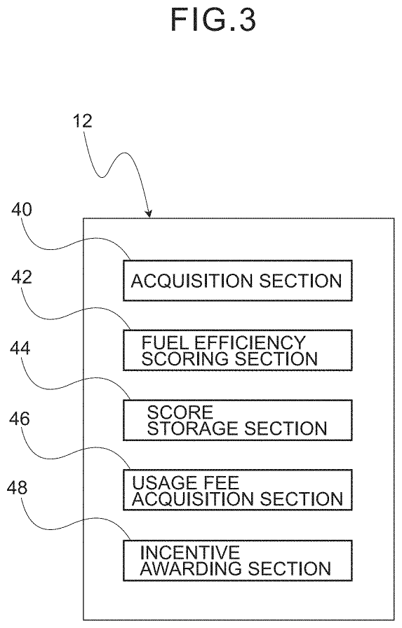

The fuel efficiency score management device 10 realizes various functionality using the above-described hardware resources. Explanation follows regarding the functional configuration realized by the fuel efficiency score management device 10, with reference to FIG. 3.

As illustrated in FIG. 3, the fuel efficiency score management device 10 is configured including an acquisition section 40, a fuel efficiency scoring section 42, a score storage section 44, a usage fee acquisition section 46, and an incentive awarding section 48 as functional configuration. Note that this functional configuration is realized by the CPU 20 reading and executing the corresponding program stored in the ROM 22 or the storage 26.

The acquisition section 40 acquires driving information as detected during driving by the sensor unit 34 installed to the vehicle. Specifically, the acquisition section 40 acquires the speed and acceleration rate of the vehicle V from the vehicle speed sensor and the acceleration sensor. The acquisition section 40 also acquires the total weight of the occupants and their baggage inside the vehicle cabin from the load sensor configuring the sensor unit 34.

The fuel efficiency scoring section 42 decides the fuel efficiency score corresponding to a reduction in carbon dioxide emissions based on the acquired driving information. Explanation follows regarding an example of a sequence in which the fuel efficiency score is decided by the fuel efficiency scoring section 42.

In the present exemplary embodiment as an example, the fuel efficiency scoring section 42 tallies predetermined behavior that impairs fuel efficiency based on the driving information, and decides the fuel efficiency score such that the fuel efficiency score becomes lower the more this behavior is present. Namely, in cases in which a maximum fuel efficiency score is 100, more points are deducted from the fuel efficiency score the greater the number of sudden accelerations and decelerations detected by the acceleration sensor. The fuel efficiency scoring section 42 also deducts more points from the fuel efficiency score the more the speed of the vehicle V changes as detected by the vehicle speed sensor.

Furthermore, the fuel efficiency scoring section 42 measures idle time of the vehicle V based on information from the acceleration sensor, and deducts more points from the fuel efficiency score the longer the idle time is. Furthermore, the fuel efficiency scoring section 42 acquires the total weight of the occupants and their baggage inside the vehicle cabin based on information from the load sensor configuring the sensor unit 34, and deducts more points from the fuel efficiency score the heavier the total weight is. This is because carbon dioxide emissions increase the heavier the total weight is when traveling over the same distance.

The fuel efficiency scoring section 42 also changes the level of deduction from the fuel efficiency score according to the type of vehicle V. For example, the level of deduction from the fuel efficiency score is less for a hybrid vehicle than for a conventional engine-powered vehicle, and the level of deduction from the fuel efficiency score is less for an electric vehicle and a fuel cell vehicle than for a hybrid vehicle. Thus, even in cases in which the number of sudden accelerations and decelerations is the same, the fuel efficiency score of a hybrid vehicle is higher than that of a conventional engine-powered vehicle, and the respective fuel efficiency scores of an electric vehicle and a fuel cell vehicle are higher than that of a hybrid vehicle.

Note that the fuel efficiency scoring section 42 reduces the level of deduction from the fuel efficiency score the further the distance that the vehicle V has traveled. Thus, even in cases in which the number of sudden accelerations and decelerations is the same, adjustment is made such that the fuel efficiency score is higher the further the distance traveled. Note that the fuel efficiency scoring section 42 may also take other elements into consideration when deciding the fuel efficiency score. For example, the fuel efficiency scoring section 42 may take the number of times a power band has been attained into consideration when deciding the fuel efficiency score.

The score storage section 44 stores the fuel efficiency score decided by the fuel efficiency scoring section 42 in the storage region 12A of the server 12. Note that in the present exemplary embodiment, a fuel efficiency score is stored for each of the vehicles V managed by the fuel efficiency score management device 10.

Each of the fuel efficiency scores stored in the storage region is updated at predetermined timings. For example, the fuel efficiency score may be updated whenever the vehicle V is used. In such cases, the score storage section 44 tallies the fuel efficiency score and stores this tally in the storage region 12A of the server 12 at the point in time when a power unit of the vehicle V has been switched OFF.

The usage fee acquisition section 46 acquires the usage fee for the vehicle V. This usage fee refers to a standard usage fee set when signing up to the subscription service, and is a normal usage fee prior to any discounts.

The incentive awarding section 48 lowers the usage fee for the vehicle V according to the fuel efficiency score over a predetermined period. Specifically, in cases in which the most recent fuel efficiency score tallied over a month is less than a predetermined score, the incentive awarding section 48 does not change the usage fee. In cases in which the fuel efficiency score is the predetermined score or above, the higher the fuel efficiency score the more the usage fee is lowered.

As an example, if the maximum fuel efficiency score is 100, the usage fee is lowered by the incentive awarding section 48 in cases in which the fuel efficiency score is 70 or above. The incentive awarding section 48 lowers the usage fee more in cases in which the fuel efficiency score is between 80 and 89 than in cases in which the fuel efficiency score is between 70 and 79. The incentive awarding section 48 lowers the usage fee still further in cases in which the fuel efficiency score is 90 or above.

### Example of Fuel Efficiency Scoring Processing

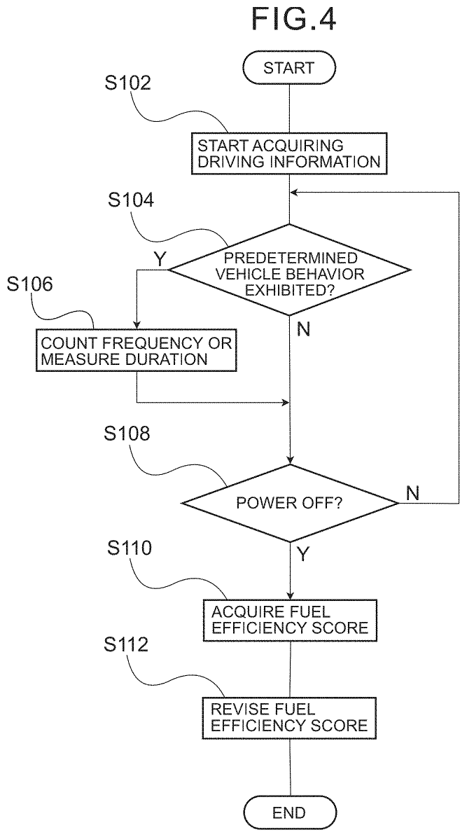

Explanation follows regarding an example of fuel efficiency scoring processing by the fuel efficiency scoring section 42, with reference to the flowchart illustrated in FIG. 4. The fuel efficiency scoring processing is executed by the CPU 20 reading the corresponding program from the ROM 22 or the storage 26 and expanding the program in the RAM 24. Moreover, the processing is executed in cases in which the power unit of one of the vehicles V has been switched ON.

As illustrated in FIG. 4, at step S102, the CPU 20 starts acquiring driving information. Namely, the CPU 20 uses the functionality of the acquisition section 40 to acquire driving information as detected during driving by the sensor unit 34 installed to the vehicle.

At step S104, the CPU 20 determines whether or not the vehicle V has exhibited predetermined behavior. Specifically, in cases in which the vehicle V has exhibited predetermined behavior that impairs fuel efficiency based on the driving information acquired by the acquisition section 40, the CPU 20 makes an affirmative determination at step S104 and processing transitions to step S106. At step S106, the CPU 20 counts the frequency or measures the duration of this behavior, and processing transitions to step S108. For example, in cases in which sudden acceleration or deceleration has been detected, the number of sudden accelerations and decelerations are counted. As another example, in cases in which idling has been detected, the idle time is measured. Note that short idle times equivalent to waiting at traffic signals may be omitted from measurement.

On the other hand, in cases in which predetermined behavior has not been exhibited at step S104, a negative determination is made at step S104 and processing transitions to step S108. At step S108, determination as made as to whether or not the power unit has been switched OFF.

In cases in which the user has switched the power unit OFF and usage of the vehicle V has ended, an affirmative determination is made at step S108, and the CPU 20 transitions to the processing of step S110. In cases in which the power unit has not been switched OFF at step S108, the CPU 20 returns to processing of step S104.

At step S110, the CPU 20 acquires the fuel efficiency score. Note that the CPU 20 acquires the fuel efficiency score from the storage region 12A of the server 12. The fuel efficiency score is a fuel efficiency score decided based on up to the most recent travel.

At step S112, the CPU 20 revises the fuel efficiency score. Specifically, the CPU 20 revises the fuel efficiency score acquired at step S110 based on the behavior of the vehicle V counted or measured at step S106. The most recent revised fuel efficiency score is then stored in the storage region 12A of the server 12. The CPU 20 then ends the fuel efficiency scoring processing.

### Example of Incentive Awarding Processing

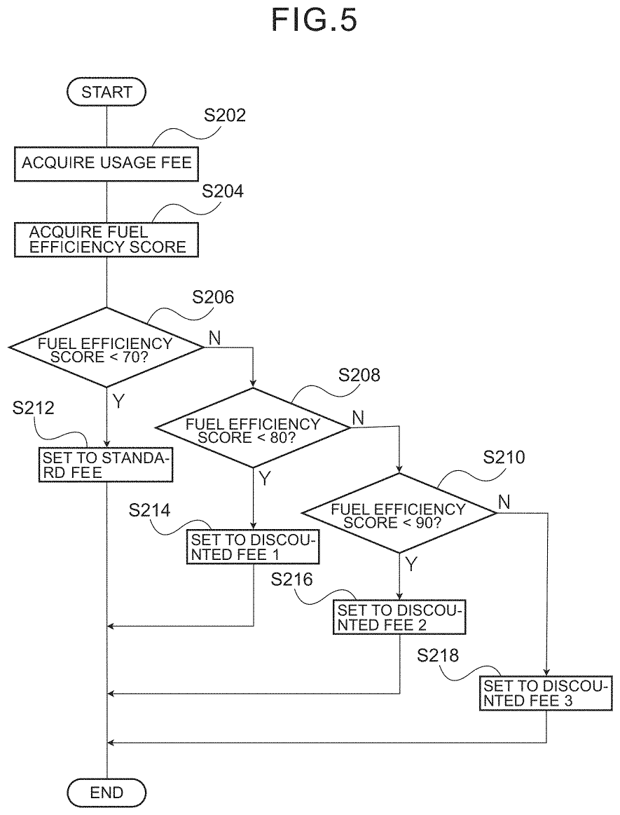

Explanation follows regarding an example of incentive awarding processing by the incentive awarding section 48, with reference to the flowchart illustrated in FIG. 5. The incentive awarding processing is executed by the CPU 20 reading the corresponding program from the ROM 22 or the storage 26 and expanding the program in the RAM 24. The incentive awarding processing is executed at a point in time when a fuel efficiency score has been established for the predetermined period. Note that although the maximum fuel efficiency score is 100 in the following explanation as an example, there is no limitation thereto.

At step S202, the CPU 20 acquires the usage fee from the storage region 12A of the server 12. This usage fee is a standard fee set when signing up to the subscription service.

At step S204, the CPU 20 acquires the fuel efficiency score. Specifically, the CPU 20 acquires the most recent fuel efficiency score of the vehicle V as stored in the storage region 12A.

At step S206, the CPU 20 determines whether or not the fuel efficiency score is less than 70. In cases in which the fuel efficiency score is less than 70, the CPU 20 transitions to the processing of step S212.

At step S212, the CPU 20 sets the usage fee to the standard fee, and ends the incentive awarding processing. Namely, the usage fee remains unchanged in cases in which the fuel efficiency score is less than 70.

On the other hand, in cases in which the fuel efficiency score is 70 or above at step S206, the CPU 20 transitions to the processing of step S208. At step S208, the CPU 20 determines whether or not the fuel efficiency score is less than 80. In cases in which the fuel efficiency score is less than 80, the CPU 20 transitions to the processing of step S214.

At step S214, the CPU 20 sets the usage fee to a discounted fee 1, and ends the incentive awarding processing.

On the other hand, in cases in which the fuel efficiency score is 80 or above at step S208, the CPU 20 transitions to the processing of step S210. At step S210, the CPU 20 determines whether or not the fuel efficiency score is less than 90. In cases in which the fuel efficiency score is less than 90, the CPU 20 transitions to the processing of step S216.

At step S216, the CPU 20 sets the usage fee to a discounted fee 2, and ends the incentive awarding processing. In cases in which the CPU 20 determines that the fuel efficiency score is 90 or above, processing transitions to step S218, whereupon the CPU 20 sets the usage fee to a discounted fee 3 and ends the incentive awarding processing. Note that the discounted fee 1 is a fee with the lowest discount rate, whereas the discounted fee 3 is a fee with the highest discount rate. Thus, the higher the fuel efficiency score the lower the usage fee that the user has to pay.

Operation

Next, explanation follows regarding operation of the present exemplary embodiment.

In the fuel efficiency score management device 10 according to the present exemplary embodiment, the incentive awarding section 48 lowers the usage fee for the vehicle V according to the stored fuel efficiency score. Since a fuel efficiency score may also be decided for the vehicle V when traveling on general roads, a usage fee discount corresponding to the fuel efficiency score may be applied to all of the vehicles V managed by the fuel efficiency score management device 10. This enables a greater number of users to be encouraged to improve their fuel efficiency score compared to systems that only target vehicles when traveling on toll roads, thereby enabling carbon dioxide emissions to be effectively cut.

Moreover, in the fuel efficiency score management device 10 according to the present exemplary embodiment, the incentive awarding section 48 lowers the usage fee according to the fuel efficiency score over the predetermined period. This enables a wide range of application to monthly payment schemes such as car leasing and subscription services.

Furthermore, in the fuel efficiency score management device 10 according to the present exemplary embodiment, the level of deduction from the fuel efficiency score is less for a hybrid vehicle than for a conventional engine-powered vehicle, and the level of deduction from the fuel efficiency score is less for an electric vehicle and a fuel cell vehicle than for a hybrid vehicle. This enables usage of vehicles that have lower carbon dioxide emissions than gasoline vehicles to be encouraged.

Note that although a configuration in which the usage fee is lowered according to the fuel efficiency score has been described in the present exemplary embodiment, there is no limitation thereto. For example, a configuration in which points are awarded to the user according to their monthly fuel efficiency score may be adopted without changing the monthly usage fee. Explanation follows regarding an example of such a configuration, with reference to a flowchart.

### Modified Example

In this modified example, similar fuel efficiency scoring processing is performed as that performed by the fuel efficiency score management device 10 of the above exemplary embodiment (see FIG. 4).

### Example of Incentive Awarding Processing

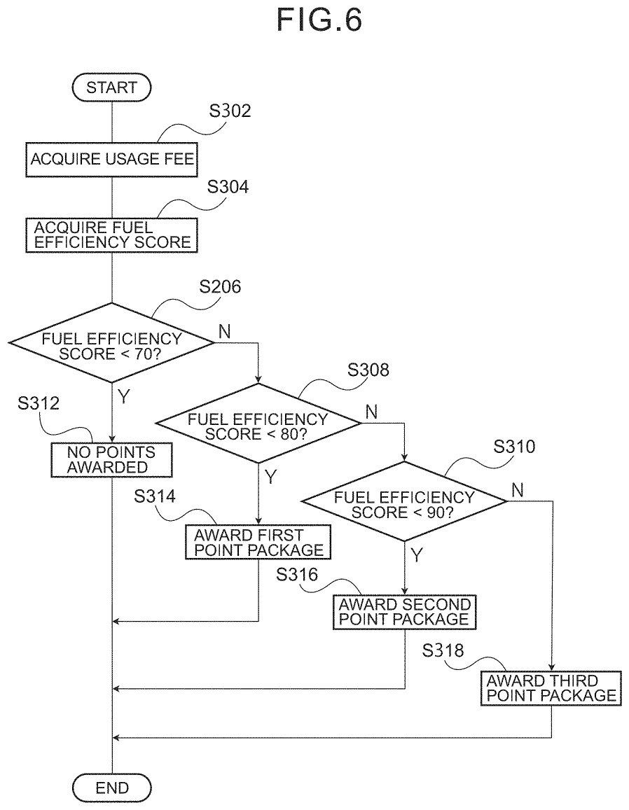

Explanation follows regarding an example of incentive awarding processing in the modified example, with reference to the flowchart illustrated in FIG. 6. The incentive awarding processing is executed by the CPU 20 reading the corresponding program from the ROM 22 or the storage 26 and expanding the program in the RAM 24. The incentive awarding processing is executed at a point in time when a fuel efficiency score has been established for a predetermined period. Note that although the maximum fuel efficiency score is 100 in the following explanation as an example, there is no limitation thereto.

As illustrated in FIG. 6, the processing of steps S302, S304, S306, S308, and S310 is substantially the same as the processing of steps S202, S204, S206, S208, and S210 in FIG. 5, and so explanation thereof is omitted.

In cases in the fuel efficiency score is less than 70 at step S306, the CPU 20 transitions to the processing of step S312. At step S312, the CPU 20 ends the incentive awarding processing without awarding points. Namely, points are not awarded in cases in which the fuel efficiency score is less than 70.

In cases in which the fuel efficiency score is less than 80 at step S308, the CPU 20 transitions to the processing of step S314. At step S314, the CPU 20 awards a first point package and ends the incentive awarding processing.

In cases in which the fuel efficiency score is less than 90 at step S310, the CPU 20 transitions to the processing of step S316. At step S316, the CPU 20 awards a second point package and ends the incentive awarding processing. On the other hand, in cases in which the fuel efficiency score is 90 or above, the CPU 20 transitions to the processing of step S318, whereupon the CPU 20 awards a third point package and ends the incentive awarding processing. Note that the first point package contains the least number of points, whereas the third point package contains the greatest number of points to be awarded to a user. Thus, the higher the fuel efficiency score the more points are awarded in the incentive awarding processing of the modified example.

The points awarded to the user may be used to cover part of the cost when purchasing predetermined goods. Alternatively, points may be exchanged for predetermined goods. As another alternative, points may be used to cover part or all of the usage fee.

Although the fuel efficiency score management device 10 according to an exemplary embodiment and a modified example has been described above, obviously various modifications may be implemented within a range not departing from the spirit of the present disclosure. For example, although a configuration in which the usage fee is lowered in stages according to the fuel efficiency score has been described in the above exemplary embodiment, there is no limitation thereto. The value of the fuel efficiency score may for example be reflected in the discount rate, such that the usage fee discount rate increases by 1% each time the fuel efficiency score increases by 1 point. In such cases, since the drop in the usage fee is more segmented, the user is kept motivated until the end of the tally period.

Moreover, although the fuel efficiency score is decided based on information including sudden acceleration and deceleration, idle time, and total weight in the above exemplary embodiment, there is no limitation thereto. The fuel efficiency score may be decided by taking other information into consideration. For example, the fuel efficiency score may be lowered in cases in which the vehicle takes a detour en route to its destination, or in cases in which the vehicle travels on congested roads.

Note that the processing executed by the CPU 20 reading and executing programs in the above exemplary embodiment may be executed by various types of processors other than the CPU 20. Such processors include programmable logic devices (PLDs) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). Moreover, the fuel efficiency scoring processing and the incentive awarding processing may be executed by any one of these various types of processors, or by a combination of two or more of the same type or different types of processors, such as plural FPGAs, or a combination of a CPU and an FPGA. The hardware structure of these various types of processors is more specifically an electric circuit combining circuit elements such as semiconductor elements.

Although a configuration in which various data is stored in the storage 26 has been described in the above exemplary embodiment, there is no limitation thereto. For example, a storage section may be configured by a non-transitory recording medium such as a compact disc (CD), a digital versatile disc (DVD) or universal serial bus (USB) memory. In such cases, various programs, data, and so on are held on the recording medium.

What is claimed is:

1. A fuel efficiency score management device comprising a processor, the processor being configured to:
acquire driving information as detected during driving by a sensor unit installed at a vehicle;
decide a fuel efficiency score corresponding to a reduction in carbon dioxide emissions based on the acquired driving information;
store the fuel efficiency score; and
lower a usage fee for the vehicle according to the stored fuel efficiency score.

2. The fuel efficiency score management device of claim 1, wherein the processor is configured to acquire a usage fee for the vehicle, and to lower the usage fee according to the fuel efficiency score over a predetermined period.

3. The fuel efficiency score management device of claim 1, wherein the processor is configured to give a higher fuel efficiency score to a hybrid vehicle than to a conventional engine-powered vehicle, and to give a higher fuel efficiency score to an electric vehicle or a fuel cell vehicle than to a hybrid vehicle.

4. The fuel efficiency score management device of claim 1, wherein the processor is configured to decide the fuel efficiency score based on predetermined behavior including an idling time of the vehicle.

5. The fuel efficiency score management device of claim 1, wherein the processor is configured to deduct more points from the fuel efficiency score the more a speed of the vehicle changes as detected by a vehicle speed sensor configuring the sensor unit.

6. The fuel efficiency score management device of claim 1, wherein the processor is configured to acquire a total weight of occupants and baggage inside a vehicle cabin based on information from a load sensor configuring the sensor unit, and to deduct more points from the fuel efficiency score the heavier the total weight is.

7. A fuel efficiency score management device comprising a processor, the processor being configured to:
acquire driving information as detected during driving by a sensor unit installed at a vehicle;
decide a fuel efficiency score corresponding to a reduction in carbon dioxide emissions based on the acquired driving information;
store the fuel efficiency score together with user information; and
award points to a user according to the stored fuel efficiency score.

8. The fuel efficiency score management device of claim 7, wherein the processor is configured to give a higher fuel efficiency score to a hybrid vehicle than to a conventional engine-powered vehicle, and to give a higher fuel efficiency score to an electric vehicle or a fuel cell vehicle than to a hybrid vehicle.

9. The fuel efficiency score management device of claim 7, wherein the processor is configured to decide the fuel efficiency score based on predetermined behavior including an idling time of the vehicle.

10. The fuel efficiency score management device of claim 7, wherein the processor is configured to deduct more points from the fuel efficiency score the more a speed of the vehicle changes as detected by a vehicle speed sensor configuring the sensor unit.

11. The fuel efficiency score management device of claim 7, wherein the processor is configured to acquire a total weight of occupants and baggage inside a vehicle cabin based on information from a load sensor configuring the sensor unit, and to deduct more points from the fuel efficiency score the heavier the total weight is.

12. A fuel efficiency score management method comprising, by a processor:
acquiring driving information as detected during driving by a sensor unit installed at a vehicle;
deciding a fuel efficiency score corresponding to a reduction in carbon dioxide emissions based on the acquired driving information;
storing the fuel efficiency score; and
lowering a usage fee for the vehicle according to the stored fuel efficiency score.
